(19) United States
(12) Patent Application Publication
(10) Pub. No.: US 2013/0080755 A1
(43) Pub. Date: Mar. 28, 2013

(54) METHOD FOR SPEEDING UP THE BOOT TIME OF ELECTRIC DEVICE AND ELECTRIC DEVICE USING THE SAME

(71) Applicants: Wen-Tai Lin, New Taipei City (TW); Yu-Jyun Tang, New Taipei City (TW); Yuan-Chan Lee, New Taipei City (TW)

(72) Inventors: Wen-Tai Lin, New Taipei City (TW); Yu-Jyun Tang, New Taipei City (TW); Yuan-Chan Lee, New Taipei City (TW)

(73) Assignee: WISTRON CORP., New Taipei City (TW)

(21) Appl. No.: 13/339,765

(22) Filed: Dec. 29, 2011

(30) Foreign Application Priority Data
Sep. 23, 2011 (TW) 100134295

(51) Int. Cl. G06F 9/00

(52) U.S. Cl. 713/2

(57) ABSTRACT

A method for speeding up the boot time of an electric device and the electric device are disclosed. The disclosed method includes measuring power consumption of the electric device and determining whether the power consumption is greater than a threshold level, wherein the measuring and the determining steps are executed during a boot process of the electric device. If the power consumption is greater than the threshold level, a connector port controller initialization procedure is performed during the boot process, to initialize the connector port controller accordingly. If the power consumption is not greater than the threshold level, a simplified form of the connector port controller initialization procedure is performed during the boot process, to speed up the boot time.

This Application claims priority of Taiwan Patent Application No. 100134295, filed on Sep. 23, 2011, the entirety of which is incorporated by reference herein.

### BACKGROUND OF THE INVENTION

1. Field of the Invention

The present invention relates to methods for speeding up the boot time of electric devices, and in particular relates to electric devices using the same.

2. Description of the Related Art

Generally, a boot process is generally required prior to starting an operating system of an electric device. The boot process typically involves hardware initialization, hardware detection and operating system guidance and so on, consuming considerable time.

Speeding up the boot process of electric devices is an important issue in related technical fields.

### BRIEF SUMMARY OF THE INVENTION

A method for speeding up the boot time of electric devices and electric devices using the same are disclosed.

In accordance with an exemplary embodiment of the invention, a method for speeding up the boot time of electric devices comprises the below steps. According to the method, the power consumption of an electric device is measured in a boot process of the electric device, and it is determined whether the power consumption is greater than a threshold value. When the power consumption is greater than the threshold value, a connector port controller initialization procedure is executed during the boot process to initialize the connector port controller. When the power consumption is not greater than the threshold value, a simplified form of the connector port controller initialization procedure is provided during the boot process, to speed up the boot process.

An electric device in accordance with an exemplary embodiment of the invention comprises a connector port controller, a power consumption measurement module and a memory. The connector port controller is operative to control an external device. The power consumption measurement module is operative to measure power consumption of the electric device in the boot-up process of the electric device. The program code for establishing a basic input/output system is loaded in the memory. The basic input/output system provides the boot process, and modifies the boot process according to whether the power consumption measured by the power consumption module is greater than a threshold value. When the power consumption is greater than the threshold value, the basic input/output system executes a connector port controller initialization procedure during the boot process. When the power consumption is not greater than the threshold value, the basic input/output system provides a simplified form of the connector port controller initialization procedure during the boot process.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 depicts an electric device 100 in accordance with an exemplary embodiment of the invention;

FIG. 2 is a flowchart showing a boot process provided by a basic input/output system (BIOS) in support of an extensible firmware interface (EFI); and

FIG. 3 is a flowchart showing an adaptive mechanism between the power consumption saving and procedure design.

### DETAILED DESCRIPTION OF THE INVENTION

The following description shows several exemplary embodiments carrying out the invention. This description is made for the purpose of illustrating the general principles of the invention and should not be taken in a limiting sense. The scope of the invention is best determined by reference to the appended claims.

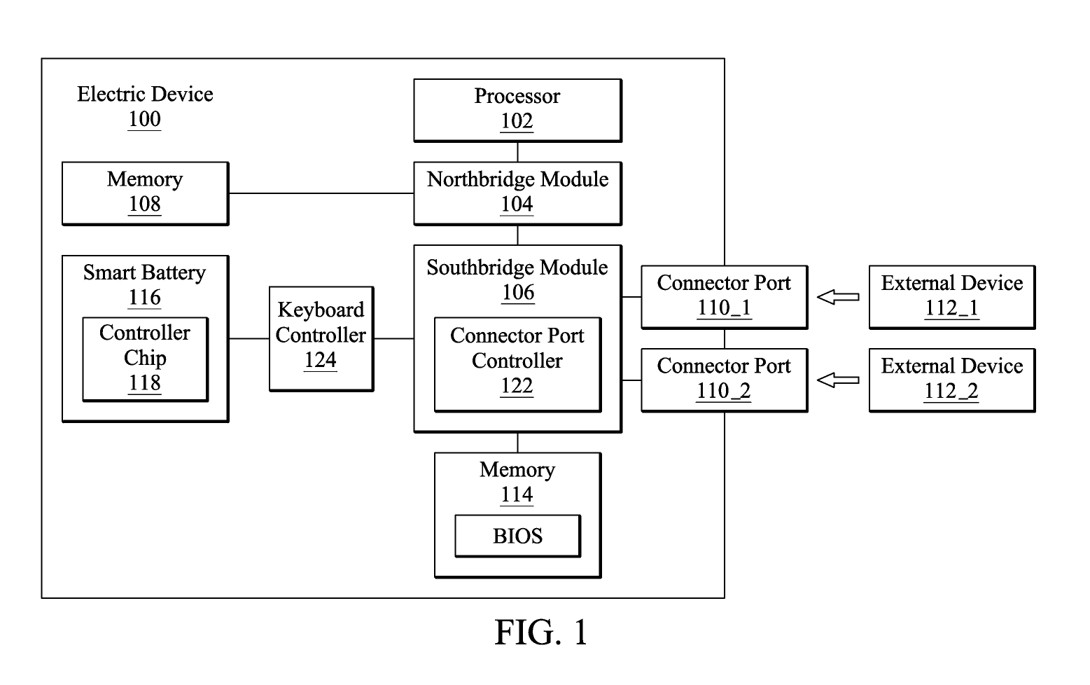

FIG. 1 depicts an electric device 100 in accordance with an exemplary embodiment of the invention. The structure of the electric device 100 is discussed below.

A processor 102 may communicate with other components of the electric device 100 by a chipset consisting of a northbridge module 104 and a southbridge module 106. The northbridge module 104 is for high-speed data transmission, and, as shown, may be connected to a memory 108. The southbridge module 106 is used in communicating with peripheral devices. For example, the southbridge module 106 may be connected to connector ports 110_1 and 110_2 to communicate with external devices 112_1 and 112_2.

Further, the southbridge module 106 may be coupled to a memory 114. The memory 114 may be a random access memory (ROM) or a flash memory (FLASH) or an electrically-erasable programmable read-only memory (EEPROM), on which a program code for building a basic input/output system (BIOS) is loaded (hereinafter the program code is symbolized as BIOS as well). The program code BIOS is executed to build the basic input/output system (BIOS) for providing a boot process for the electric device 100.

Further, when being implemented as a portable electric device, the electric device 100 may use a smart battery 116. As shown, the smart battery 116 is coupled to the southbridge module 106 by a keyboard controller 124. The smart battery 116 has a controller chip 118 which provides information about power consumption of the battery.

The southbridge module 106 is generally designed with a connector port controller 112 (or, in some exemplary embodiments, the keyboard controller 124 is designed within the southbridge module.) The connector port controller 122 is operative to control the external devices 112_1 and 112_2 connected at the connector ports 110_1 and 110_2. The connector ports 110_1 and 110_2 may use a universal serial bus (USB) protocol, and the connector port controller 122 may be a USB controller. The keyboard controller (KBC) 124 is also known as an embedded controller. Concerning the applications of the embedded controller, the smart battery 116 may communicate with the keyboard controller 124 by a system management bus (smbus).

The basic input/output system is specially designed in this disclosure. During the boot process, the basic input/output bus (BIOS) may communicate with keyboard controller 124 via a memory space or input/output space, to control the keyboard controller 124 to obtain the information about power consumption (via the system management bus) from the controller chip 118 of the smart battery 116. Thus, the power consumption of the electric device 100 is evaluated and the operations of a power consumption measurement module are completed. By determining whether the power consumption of the electric device 100 is greater than a threshold value, the basic input/output system (BIOS) modifies the boot process. For example, when the power consumption is greater than the threshold value, it may be determined that the connector ports 110_1 and 110_2 are actually connected to external devices 112_1 and 112_2. Accordingly, the basic input/output system executes a connector port controller initialization procedure (e.g. an USB controller initialization procedure) to initialize the connector port controller 122. The connector port controller initialization procedure enumerates and initializes the external device 112_1 and 112_2. Otherwise, when the power consumption is not greater than the threshold value, it may be determined that a lesser number of external devices (e.g. only 112_1 or only 112_2) or even no external device is connected to the electric device 100. Accordingly, the basic input/output system BIOS provides a simplified form of the connector port controller initialization procedure during the boot process. In one exemplary embodiment, steps for initializing external devices are removed from the connector port controller initialization procedure, to speed up the boot time. In another exemplary embodiment, the connector port controller initialization procedure is completely removed. In this case, the initialization of the connector port controller 122 is not performed until being required, and the initialization is performed by the operating system.

Note that the structure shown in FIG. 1 is not intended to limit the scope of the invention. Any technique which measures and judges the power consumption during the boot process and modifies the boot process in accordance with the power consumption should be regarded as within the scope of the invention. The disclosed adaptive mechanism between the power consumption saving and procedure design may be utilized in the design of the boot process of electric devices of any architecture.

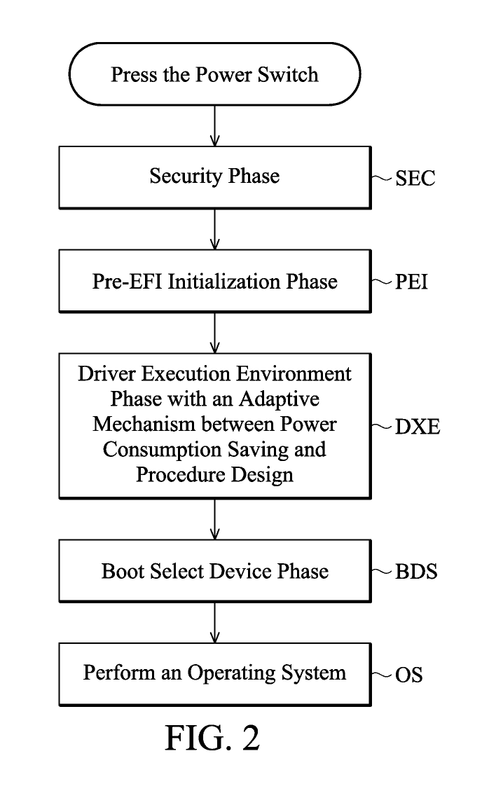

A basic input/output system nowadays may be developed by an extensible firmware interface, as know as EFI BIOS (or UEFI BIOS). FIG. 2 is a flowchart depicting a boot process provided by a basic input/output system in support of an extensible firmware interface.

As shown in FIG. 2, after the power switch is pressed by the user, a boot process provided by the EFI BIOS may enter a security phase (SEC), then a Pre-EFI initialization phase (PEI), then a driver execution environment phase (DXE) and then a boot select device phase (BDS). After the four phases SEC, PEI, DXE and BDS are finished, the electric device is operated by an operating system (an OS phase). In an exemplary embodiment, the disclosed adaptive mechanism between the power consumption saving and procedure design is performed in the driver execution environment phase (DXE), to speed up the boot process of the electronic device.

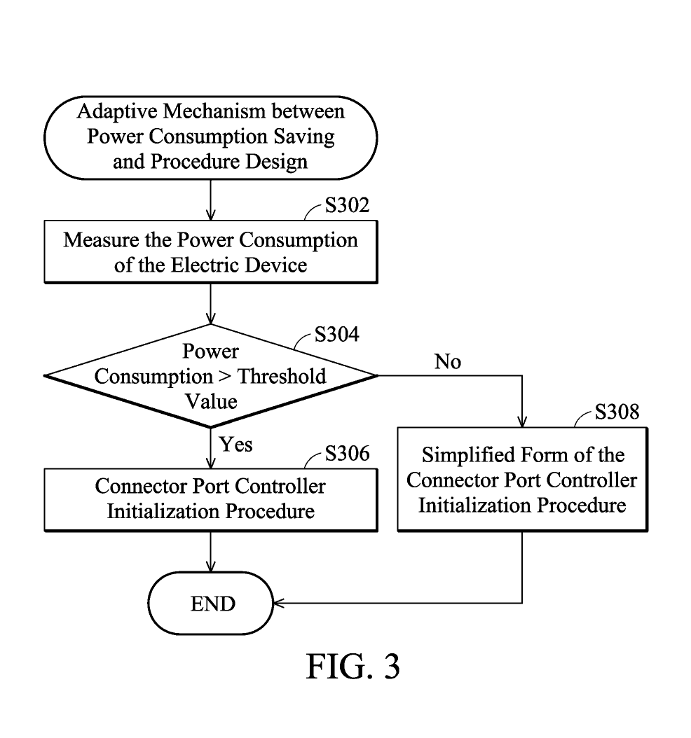

FIG. 3 is a flowchart depicting the adaptive mechanism between the power consumption saving and procedure design. Firstly, in step S302, the power consumption of the electric device is measured. In step S304, it is determined whether the power consumption is greater than a threshold value. When the power consumption is greater than the threshold value, step S306 is performed, wherein a connector port controller initialization procedure is executed to initialize a connector port controller (e.g. an USB controller). When the power consumption is not greater than the threshold value, step S308 is performed, wherein a simplified form (in comparison with the procedure of step S306) of the connector port controller initialization procedure is executed. In an exemplary embodiment, steps for initializing an external device, contained in the connector port controller initialization procedure of step S306, are omitted in the procedure of step S308, and thereby the boot time is sped up. In another exemplary embodiment of the step S308, the connector port controller initialization procedure is completely removed, and the connector port controller is not initialized until it is required, and, the initialization of the connector port controller is performed by the operating system.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for speeding up a boot time of an electric device, comprising
measuring power consumption of the electric device in a boot process of the electric device and determining whether the power consumption is greater than a threshold value;
executing a connector port controller initialization procedure during the boot process when the power consumption is greater than the threshold value, to initialize a connector port controller of the electric device accordingly; and
adopting a simplified form of the connector port controller initialization procedure during the boot process when the power consumption is not greater than the threshold value, to speed up the boot process.

2. The method as claimed in claim 1, wherein in the simplified form of the connector port controller initialization procedure, steps for initializing external devices are omitted.

3. The method as claimed in claim 1, wherein the simplified form of the connector port controller initialization procedure is implemented by completely removing the connector port controller initialization procedure.

4. The method as claimed in claim 1, further comprising:
providing the electric device with a smart battery, wherein the smart battery communicates with a keyboard controller of the electric device via system management bus,
wherein the measuring of the power consumption is implemented by the keyboard controller which obtains information about the smart battery via the system management bus.

5. The method as claimed in claim 4, wherein the keyboard controller is operated by a basic input/output system via a memory space or input/output space.

6. The method as claimed in claim 1, further comprising:
using a basic input/output system in support of an extensible firmware interface to provide the boot process,
wherein the measuring and determining about the power consumption and the connector port controller initialization procedure are executed when the boot process is in a driver execution environment phase.

7. The method as claimed in claim 6, further comprising:
providing the electric device with a smart battery, wherein the smart battery communicates with an keyboard controller of the electric device via system management bus,
wherein the measuring of the power consumption is implemented by the keyboard controller which obtains information about the smart battery via the system management bus.

8. The method as claimed in claim 7, wherein the basic input/output system operates the keyboard controller via a memory space or input/output space.

9. The method as claimed in claim 8, wherein in the simplified form of the connector port controller initialization procedure, steps for initializing external devices are omitted.

10. The method as claimed in claim 8, wherein the simplified form of the connector port controller initialization procedure is implemented by completely removing the connector port controller initialization procedure.

11. An electric device, comprising:
a connector port controller, operative to control an external device;
a power consumption measurement module, measuring power consumption of the electric device in a boot process of the electric device; and
a memory, loaded with a program code of a basic input/output system;
wherein:
the program code is executed to build the basic input/output system to provide the boot process and, according to whether the power consumption measured by the power consumption measurement module is greater than a threshold value, the boot process is modified;
the basic input/output system executes a connector port controller initialization procedure during the boot process when the power consumption is greater than the threshold value, to initialize a connector port controller of the electric device accordingly; and
the basic input/output system executes a simplified form of the connector port controller initialization procedure during the boot process, to speed up the boot time.

12. The electric device as claimed in claim 11, wherein the basic input/output system omits steps of initializing external devices from the connector port controller initialization procedure to provide the simplified form of the connector port controller initialization procedure.

13. The electric device as claimed in claim 11, wherein in the simplified form, all steps of the connector port controller initialization procedure are completely removed by the basic input/output system.

14. The electric device as claimed in claim 11, powered by a smart battery and comprising a keyboard controller, wherein the keyboard controller, operated by the basic input/output system, obtains information about the smart battery via system management bus and thereby implements the power consumption measurement module.

15. The electric device as claimed in clam 14, wherein the basic input/output system operates the keyboard controller via a memory space or input/output space.

16. The electric device as claimed in claim 11, wherein:
the basic input/output system is in support of an extensible firmware interface;
the power consumption measurement module measures the power consumption when the boot process is in a driver execution environment phase; and
the connector port controller initialization procedure is executed when the boot process is in the driver execution environment phase.

17. The electric device as claimed in claim 16, powered by a smart battery and comprises a keyboard controller, wherein the keyboard controller, operated by the basic input/output system, obtains information about the smart battery by system management bus and thereby implements the power consumption measurement module.

18. The electric device as claimed in claim 17, wherein the basic input/output system operates the keyboard controller via a memory space or input/output space.

19. The electric device as claimed in claim 18, wherein the basic input/output system omits the steps of initializing external devices from the connector port controller initialization procedure to provide the simplified form of the connector port controller initialization procedure.

20. The electric device as claimed in claim 18, wherein in the simplified form, all steps of the connector port controller initialization procedure are completely removed by the basic input/output system.
